(19) United States
(12) Patent Application Publication
(10) Pub. No.: US 2013/0142432 A1
(43) Pub. Date: Jun. 6, 2013

(54) METHOD OF TRACKING TARGETS IN VIDEO DATA

(71) Applicant: Trevor Michael Wood, Oxford (GB)

(72) Inventor: Trevor Michael Wood, Oxford (GB)

(73) Assignee: ISIS INNOVATION LIMITED, Oxford (GB)

(21) Appl. No.: 13/634,045

(22) PCT Filed: Feb. 3, 2011
(86) PCT No.: PCT/GB11/00144

§ 371 Date: Dec. 18, 2012

(30) Foreign Application Priority Data
Mar. 17, 2010 (GB) 1004488.1

(51) Int. Cl. G06K 9/32

(52) U.S. Cl. CPC G06K 9/3241
USPC 382/195

(57) ABSTRACT

A method of tracking targets in video data. At each of a sequence of time steps, a set of weighted probability distribution components is derived. At each time step the following steps are performed. First, a new set of components from the components of the previous time step are derived in accordance with a predefined motion model for the targets. The video at the current time step is then analysed to obtain a set of measurements, and the new set of components is updated using the measurements in accordance with a predefined measurement model. Finally, the set of components derived at each time step are analysed to derive a set of tracks for the targets.

### BACKGROUND OF THE INVENTION

The present invention concerns methods for tracking targets in video data. A target may be any object in the video that is to be tracked. Examples of targets include, but are not limited to, persons recorded in CCTV (closed-circuit television) footage, and cells viewed through a microscope moving through a sample fluid.

The present invention relates to the tracking of targets in video, or visual, data, for example tracking objects that have been recorded in a video. The video data may be a pre-recorded video clip, or a real-time video feed, for example. Each frame of the video will be an image in which one or more of the targets may be visible. The present invention relates to a method of analysing the frames of such a video so as to identify the targets and track them as they move through the area captured by the video.

A particular characteristic of the tracking targets in video data is that the number of targets present in any particular frame of the video is unknown, and can change over time (e.g. as cells move into and out of the area of fluid captured by a microscope).

A method of tracking cells is described in Taboada, Poggio, Camarena and Corkidi, Automatic tracking and analysis system for free-swimming bacteria, Proceedings of the 25th Annual International Conference of the IEEE EMBS, 2003. This method identifies any likely cells in a frame of a video as the areas of contrasting colour and/or brightness, for example the cells may be identified as the “bright spots” in each frame. The paths of the cells are then identified using those areas overlap from frame to frame.

There are a number of problems associated with this method. Video frames will contain noise, which may cause areas to be incorrectly identified as cells, and conversely cause cells to fail to be identified. This can cause errors to be made when identifying paths, and a particular problem is broken paths (that is, the path of a single cell may be identified as number of shorter, separate paths). Another problem is that cells may move very quickly, for example up to 200 times their body length in a second. This means that a very high frame rate is required in order for the cells to overlap between frames, which has disadvantages such as requiring very large video files and effectively limiting the duration of videos that can be analysed. Another problem is that the method has difficulty differentiating between and correctly tracking cells that are in close proximity or which have overlapping paths, making it unreliable when there are a large number of cells.

Various other methods of tracking cells are known, but these are commonly able to track only a single or very small number of cells.

A known method of modelling a random number of moving targets is the Probability Hypothesis Density (PHD) filter. The PHD filter is conventionally used to model moving targets in data obtained from radar or sonar. However, methods of tracking targets in CCTV data using the PHD filter, are described in Wang, Wu, Kassim and Huang, Data-Driven Probability Hypothesis Density Filter for Visual Tracking, IEEE Transactions on Circuits and Systems for Video Technology, 2008, and in Maggio, Taj and Cavallaro, Efficient multi-target visual tracking using Random Finite Sets, IEEE Transactions on Circuits and Systems for Video Technology, 2008. The methods described in these documents use an implementation of the PHD filter known as the “particle” filter, or sequential Monte Carlo method. There are a number of problems with the methods described in these documents. The methods may not be robust when the data is noisy, leading to broken and incorrectly declared tracks. Further, they are unable to take into account prior information about where new targets are likely to appear. The methods are also very computationally expensive.

The present invention seeks to provide an improved method of tracking targets, which avoids or mitigates some or all of the above-mentioned problems.

### SUMMARY OF THE INVENTION

According to a first aspect of the invention there is provided a method for tracking targets in video data, wherein at each of a sequence of time steps a set of weighted probability distribution components is derived, comprising at each time step the steps:
deriving a new set of components from the components of the previous time step in accordance with a predefined motion model for the targets;
analysing the video at the current time step to obtain a set of measurements;
updating the new set of components using the measurements in accordance with a predefined measurement model;
analysing the set of components derived at each time step to derive a set of tracks for the targets.

The method models potential targets using the weighted probability distribution components; the weighting of the components represents the amount of evidence that a target is indeed at the position indicated by the component. At each time step, the components are updated using a model of how they are expected to behave (the predefined motion model), and with measurements obtained from the video data of the targets (using the predefined measurement model). The components that result at each step are analysed to derive the target tracks, in other words to track the targets.

Using the method multiple targets can be more reliably identified and tracked, particularly in cases where the video contains noise that results in unreliable measurements. The method, is particularly effective in tracking targets over their entire path, in other words without returning broken tracks, and at not misidentifying distinct targets as the same target, for example when their paths cross. Further, the method does not require that the targets overlap between frames of the video.

The method is particularly suited to tracking the movement of microscopic objects such as cells in a sample of fluid.

Advantageously, the probability distribution components are Gaussian distributions. Gaussian distributions provide a computationally efficient model, as they can be easily characterised and have simple properties, while still providing an effective method.

Preferably, the predefined motion model comprises:
a survival model that models the expected behaviour of targets that survive from the previous time step; and
an appearance model that models the expected behaviour of targets that were not present in the previous time step. This helps allow the expected behaviour of targets to be effectively modelled. Advantageously, the appearance model indicates that targets are expected to appear on the boundaries of the area captured by the video. This provides a more robust method, avoiding measurements within the boundary (which are likely to be noise or already existing targets) being misidentified as new targets. The predefined motion model may further comprise a branching model that models the expected behaviour of targets that produce additional targets from the previous time step. This helps the effective tracking of targets that produce new cells, for example cells that split into two or more cells.

Preferably, the method further comprises at each time step the step of deleting any components whose weight is below a predetermined amount. This helps prevent the number of components from becoming unmanageably large, so provides a computationally efficient model. Preferably, the method further comprises at each time step the step of merging any components that are within a predetermined threshold. The method may further comprise at each time step the step of deleting all but a predetermined number of components consisting of the components with the highest weights.

Preferably, the method further comprises at each time step the step of labelling the set of components derived at that time step. This allows the tracks to be derived using the labels applied to the components.

Preferably, components obtained from the motion model are given the same label as the component from which they were derived. Advantageously, the motion model comprises a survival model, and wherein a component obtained from the survival model is given the same label as the component from which it derived. Advantageously, the motion model comprises an appearance model, and wherein components obtained from the appearance model are given a new unique label. The motion model may comprise a branching model, and the component with the highest weight obtained from the branching model be given the same label as the component from which it derives. Advantageously, a track is derived from a sequence of components from consecutive time steps with the same label. This allows tracks to be derived by identifying components with the same label that are maintained over successive consecutive time steps.

Advantageously, a track is eliminated if the weights of the components from which the track is derived are below a predetermined threshold. This helps prevent tracks being identified on the basis of components which are unlikely to be derived from genuine targets.

Advantageously, if the start of a second track is within a predetermined time and distance of the end of a first track, the first track and second track are linked to form a single track. This helps reduce the broken tracks identified by the method.

Advantageously, the motion model is updated based on the tracks of the targets. This allows the method to track targets more accurately, as the motion model more accurately predicts the motion of the particular targets being tracked.

According to a second aspect of the invention there is provided a computer program product arranged to perform the steps of any of the methods described above.

### DESCRIPTION OF THE DRAWINGS

Embodiments of the present invention will now be described by way of example only with reference to the accompanying figures of which:

FIG. 1 is a flowchart showing a method of tracking cells according to a first embodiment of the invention;

FIG. 2 is a flowchart showing in more detail the pruning/merging of components in the method of FIG. 1;

FIG. 3 is a flowchart showing the labelling of components in the method of FIG. 1; and

FIG. 4 is a flowchart showing the declaration and linking of tracks in the method of FIG. 1.

### DETAILED DESCRIPTION

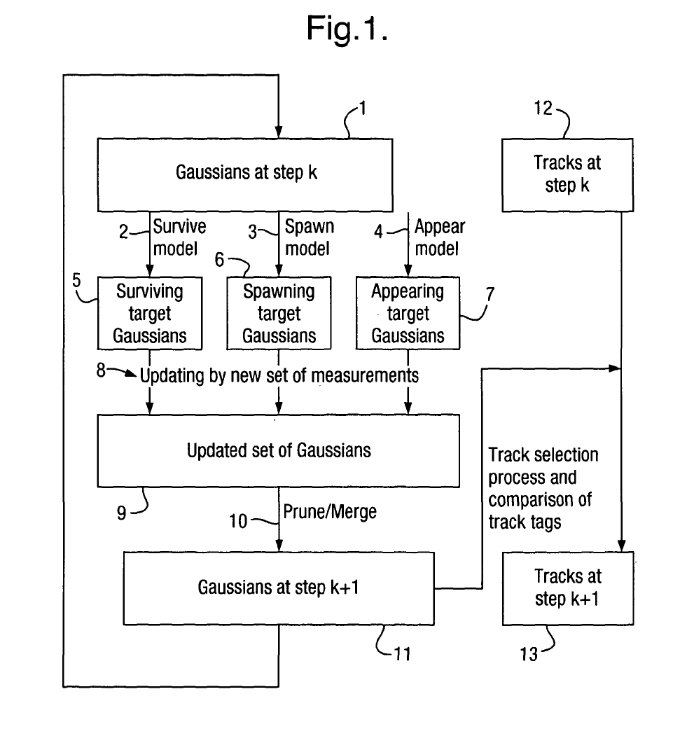

An embodiment of the present invention is now described with reference to FIGS. 1 to 4.

As mentioned above, the PHD filter is a known method for modelling moving targets. A description of the general concept of a PHD filter is as follows.

A PHD is a generalisation of the well-known probability density function (PDF) used in probability theory. A PDF for a continuous random variable is a function that gives the likelihood that the random variable will occur at a given point in the domain of the function. The probability that the random variable will occur within a particular set of values is given by the integral of the PDF over those values. The domain of the probability function is the complete set of possible values for the random variable, and consequently the integral of the probability density function over the whole of its domain is 1 (reflecting the fact that the random variable must in practice occur at some point in the domain). To put this in the context of the present embodiment, the random variable might be the position of a cell within an image. The probability density function for this random variable then has as its domain the entire image, and the integral of the probability density function over a particular area of the image gives the probability that the cell is within that particular area.

However, as noted above, the integral of the probability density function over the entire image must be 1, and so this is only suitable for an image containing exactly one cell. The PHD is a generalisation of the probability density function that can be used to model the position of a random number of cells (which may be zero, one or more than one). More generally, the PHD indicates the likelihood of a random number of targets occurring at certain positions. A characteristic of the PHD is that the integral over a particular area gives the expected number of targets in that area, and so in particular the integral over the entire area need not be equal to 1, as there may be less or more than one target.

The PHD filter then gives a method of modelling the movement of a random number of moving targets, using successive PHDs, as follows. Underlying the PHD filter is a set Xₜ of target states, which is a set of vectors indicating the states of each of the targets (e.g. their positions and velocities) at time t.

The expected behaviour of the targets over time is given by an underlying motion model, which might be as follows:

$${X}_{t} = ( {⋃}_{x ∈ {X}_{t - 1}} {S}_{t \vert t - 1} ( x ) ) ⋃ ( {⋃}_{x ∈ {X}_{t - 1}} {B}_{t \vert t - 1} ( x ) ) ⋃ {Γ}_{t}$$

The motion model gives the probability distribution of targets states Xₜ at time t, based on the target states Xₜ₋₁ at the preceding time t−1. This model assumes that there are three main behaviours that targets can exhibit, as described below.

S_{t|t-1} is a model for surviving targets. For a particular target x, S_{t|t-1}(x) gives the probability distribution of the target state at time t based on its state at time t−1. A target may disappear, for example if it moves over the boundary of the area; if it does not disappear then it will have a new expected position and velocity. For example, a model might be:

$${S}_{t \vert t - 1} ( x ) = \{ \begin{matrix}{F}_{t \vert t - 1} ( x ) & with probability 1 - p ( x ) \\ ∅ & with probability p ( x )\end{matrix}$$

where p(x) is the probability that a target will disappear, and F_{t|t-1} is its expected new positions and velocity if it does not disappear.

B_{t|t-1} is a model for branching targets. For a particular target x, B_{t|t-1}(x) gives the probability distribution of the states of targets spawned by the target x. So, for example a cell may split into two cells, and the branching model would capture the likelihood of a target x spawning a new target, and the expected state of any new targets.

Finally, Γₜ is a model for new targets. This gives the state of any new targets created independently of existing targets, for example targets appearing on the boundaries of the area. As these new targets are created independently of existing targets (unlike new targets created as a result of branching), this does not depend on the state of any targets at time t−1.

There is also a measurement model underling the PHD filter. The measurement model gives the probability distribution of the measurements Zₜ at time t, based on the target states Xₜ. (The measurements will in practice come from analysis of the video data showing the targets.) A measurement model might be:

$${Z}_{t} {K}_{t} ⋃ ( {⋃}_{x ∈ {X}_{t}} {Θ}_{t} ( x ) )$$

where Kₜ is a model for noise and clutter, and Θₜ is a model of measurements received due to the targets themselves (and may capture the probability that a target is not detected for some reason, and so results in no measurement).

The underlying set of target states, motion model and measurement model can be used with the PHD filter as follows. At each time t, there will be a new set of measurements Zₜ obtained from the video data for the time step, and a PHD from the previous time step t−1. (For the initial step there will of course be no PHD for a previous time step, and so for example a PHD that is zero everywhere may be used.) An expected underlying set of target states Xₜ₋₁ can be derived from the PHD. For example, by integrating the PHD over the whole area the expected number of targets n can be identified, and then the n highest peaks in the PHD can be taken as the positions and velocities of the targets.

The underlying motion model is then used to give, from the set of target states Xₜ₋₁, a probability distribution for the current set of target states Xₜ. In addition, the underlying measurement model is used to give, from the set of measurements Zₜ, a further probability distribution (usually called a likelihood function in this context) for the measurement received, conditioned on the target state Xₜ₋₁. The two probability distributions for Xₜ are then combined (using a form of the Bayes probability rule) to give the final probability distribution for Xₜ, which is the PHD for the time step t.

The described method in principle allows PHDs to be used to model the movement of multiple targets. However, in practice this method is computationally infeasible, and so an implementation that approximates the PHD filter must be used. The implementation of the present embodiment approximates the PHD using a set of weighted Gaussian components, in other words Gaussian probability functions. This is known as the Gaussian mixture implementation of the PHD filter, or GM-PHD. A description of GM-PHD is given in Vo and Ma, The Gaussian Mixture Probability Hypothesis Density Filter, IEEE Transactions Signal Processing, 2006, for example.

A flowchart describing the GM-PHD implementation is shown in FIG. 1. In the GM-PHD implementation, the PHD for each time step is approximated by a set of weighted Gaussian components 1. Gaussian probability functions can be completely described by their means and covariances, and so each component can be described by its weight, mean and covariance. Very broadly, a component corresponds to a possible target; the position of the target is given by the mean of the component, and the covariance indicates the confidence that the mean is the actual position of the target (the lower the covariance, the more likely the target is at the mean position). The weight indicates the confidence that there is a target at all. So, for example, a component with low covariance but low weight might result from a very localised piece of noise (so there may well not be a target, but if there is its location is known precisely), whereas a component with high weight but high variance might result from a reliable series of spread out measurement (there is very likely a target, but its location is not known so precisely).

At time t−1, suppose there are Jₜ₋₁ Gaussian components:

{wₜ₋₁⁽ⁱ⁾,mₜ₋₁⁽ⁱ⁾,Pₜ₋₁⁽ⁱ⁾}ᵢ₌₁^{J}^{_{t−1}}

where wₜ₋₁, mₜ₋₁ and Pₜ₋₁ are the weights, means and covariances of the respective components. (In accordance with the PHD filter itself, at the first time step there will of course be no previous set of Gaussian components, and so the empty set can be used.) In a first “forward” step, the Gaussian components are updated according to their expected behaviour, in other words based on a motion model corresponding to the underlying motion model of the PHD filter. The corresponding motion model of the GM-PHD implementation comprises corresponding models for surviving targets, branching targets and new targets, as follows.

The surviving target model 2 results in Jₜ₋₁ Gaussian components 5, i.e. a component corresponding to each existing component, defined as follows:

w_{t|t-1}⁽ⁱ⁾=(1−p(mₜ₋₁⁽ⁱ⁾))wₜ₋₁⁽ⁱ⁾

m_{t|t-1}⁽ⁱ⁾=Fmₜ₋₁⁽ⁱ⁾

P_{t|t-1}⁽ⁱ⁾=Q+FPₜ₋₁⁽ⁱ⁾F^{T} for i=1, . . . Jₜ₋₁

where p is the probability of disappearance of a target, F is a model for the expected motion of a single surviving target, and Q is a process noise covariance matrix for a single target. (The process noise covariance matrix represents the uncertainty of motion of a surviving target.) P, F and Q (i.e. the surviving target model) are chosen based on how the targets being tracked are expected to behave. In the case of tracking cells, for example, some information about how the cells being tracked can be expected to behave may already be known, and the surviving target model can be based on this. Notably, in this case measurements will usually in practice come from a video of a portion of a sample of fluid containing cells. One consequence of this is that one way in which cells can “die” is simply by moving over the boundary of the portion being videoed so that they are no longer visible, and this should therefore ideally be captured by the chosen model. If no information about the behaviour of the particular type of cells being tracked is available, or the types of cells being tracked is not known, a standard model may be used, for example a model based on Brownian motion (i.e. the random movement of particles in a fluid).

The branching targets model 3 results in J_{β}·Jₜ₋₁ Gaussian components 6, i.e. J_{β} components for each existing component, where J_{β} is the number of distinct branching models, defined as follows:

w_{t|t-1}^{(i+j*J}^{_{t−1}}⁾=p_{S}^{j}(mₜ₋₁⁽ⁱ⁾)wₜ₋₁⁽ⁱ⁾

m_{t|t-1}^{(i+j*J}^{_{t−1}}⁾=Fⱼmₜ₋₁⁽ⁱ⁾

P_{t|t-1}^{(i+j*J}^{_{t−1}}⁾=Qⱼ+FⱼPₜ₋₁⁽ⁱ⁾Fⱼ^{T} for i=1, . . . ,Jₜ₋₁,j=1,J_{β}

where p^{j} is the probability of a target branching, Fⱼ is a model for the expected motion of a target created by branching, and Qⱼ is again a process noise covariance matrix for a single target (each for a particular branching model j). Again, the branching model will chosen be based on how the targets are expected to move. In the case of tracking cells it may be expected that there will be no branching at all, for example, if it is not expected that the cells will split.

Finally, the new target model 4 results in M Gaussian components 7, as follows:

{w_{t|t-1}⁽ⁱ⁾,m_{t|t-1}⁽ⁱ⁾,P_{t|t-1}⁽ⁱ⁾}

Again, the new target model will be based on how new targets are expected to occur. As noted above, in the case of tracking cells the video being analysed will usually in practice be a portion of a sample of fluid containing cells, and so “new” cells are likely to occur as a result of already existing cells moving over the boundary of the portion being videoed so that they become visible, and the model chosen should capture this.

The resulting set of Gaussian components 5, 6 and 7 corresponds to the expected behaviour of the targets at the new time t. Let J_{t|t-1} be the number of resulting Gaussian components 5, 6 and 7. The sum of the weights of the components equals the expected number of targets.

The resulting set of Gaussian components 5, 6 and 7 is then updated based on the measurements taken at time t, i.e. as a result of analysing the current frame of the video (step 8 of FIG. 1). Taking the components 5, 6 and 7 to be:

{w_{t|t-1}⁽ⁱ⁾,m_{t|t-1}⁽ⁱ⁾,P_{t|t-1}⁽ⁱ⁾}ᵢ₌₁^{J}^{_{t|t=1}}

the updated set of component is then given by:

$${w}_{t}^{( i )} = \frac{{p}_{D} ( {m}_{t \vert t - 1}^{( i )} ) {w}_{t \vert t - 1}^{( i )} N ( z ; {Hm}_{t \vert t - 1} , R + {HP}_{t \vert t - 1} {H}^{T} )}{{κ}_{t} ( z ) + {p}_{D} ( {m}_{t \vert t - 1}^{( i )} ) {\sum }_{l = 1}^{{J}_{t \vert t - 1}} {w}_{t \vert t - 1}^{( i )} N ( z ; {Hm}_{t \vert t - 1} , R + {HP}_{t \vert t - 1} {H}^{T} )}$$

$${m}_{t}^{( i )} ( z ) = {m}_{t \vert t - 1}^{( i )} + {K}_{t}^{( i )} ( z - {Hm}_{t \vert t - 1}^{( i )} )$$

$${P}_{t}^{( i )} = [ I - {K}_{t}^{( i )} H ] {P}_{t \vert t - 1}^{( i )}$$

$${K}_{t}^{( i )} = {P}_{t \vert t - 1}^{( i )} {{H}^{T} ( {HP}_{t \vert t - 1} {H}^{T} + R )}^{- 1}$$

for each measurement z, where p is the probability of detection of a target, H and R are measurement and measurement noise covariant matrices for a single target, and K is a noise model. N stands for the Gaussian distribution; specifically, N(a,b) is the Gaussian distribution with mean a and Covariance b.

In addition, there is a further set of J_{t|t-1} components to take account of missed detections. These components are given by:

wₜ⁽ⁱ⁾()=(1−p_{D}(m_{t|t-1}⁽ⁱ⁾))w_{t|t-1}⁽ⁱ⁾

mᵢ⁽ⁱ⁾()=m_{t|t-1}⁽ⁱ⁾

Pₜ^{(i)()=P}_{t|t-1}⁽ⁱ⁾

Each component corresponds to a component 5, 6 and 7 resulting from the motion model; unchanged to capture the possibility that the target acted as predicted by the motion model, but was pimply not detected at time step t.

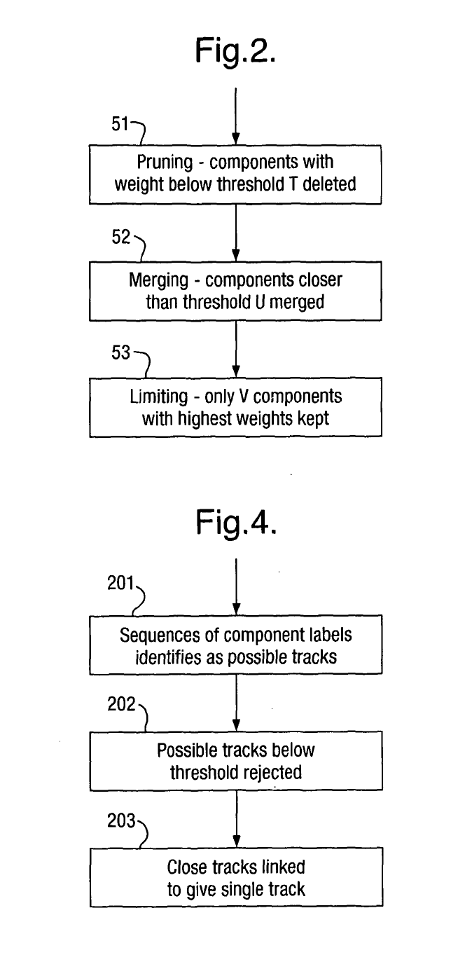

The result of updating the Gaussian components is the set of Gaussian components 9. Assuming there were n measurements z, this set contains (n+1)·J_{t|t-1} components. To avoid an unmanageable increase in the number of Gaussian components, a pruning/merging step 10 is then performed. This is shown in more detail in FIG. 2.

A first pruning 51 step simply deletes any component whose weight is below a pre-determined threshold T. A merging step 52 then merges any components that are “close”, again according to predetermined threshold. Given a set of components:

{ŵₜ⁽ⁱ⁾,\hat{m}ₜ⁽ⁱ⁾,\hat{P}ₜ⁽ⁱ⁾}ᵢ₌₁^{J}^{ᵢ}

(the result of the pruning step 51), a merging algorithm might be:

$$I = \{ i = 1 , … , {J}_{t} \}$$

$$l = 0$$

$$while$$

$$I \neq ∅$$

$$l = l + 1$$

$$j = arg {max}_{i ∈ l} ( {\hat{w}}_{t}^{( i )} )$$

$$L = \{ i ∈ I \vert {( {\hat{m}}_{t}^{( i )} - {\hat{m}}_{t}^{( j )} )}^{T} {( {\hat{P}}_{t}^{( i )} )}^{- 1} ( {\hat{m}}_{t}^{( i )} - {\hat{m}}_{t}^{( j )} ) < U \}$$

$${w}_{t}^{( i )} = {\sum }_{i ∈ L} {\hat{w}}_{t}^{( i )}$$

$${m}_{t}^{( i )} = \frac{1}{{w}_{t}^{( i )}} {\sum }_{i ∈ L} {\hat{w}}_{t}^{( i )} {\hat{x}}_{t}^{( i )}$$

$${P}_{t}^{( i )} = \frac{1}{{w}_{t}^{( i )}} {\sum }_{i ∈ L} {\hat{w}}_{t}^{( i )} ( {\hat{P}}_{t}^{( i )} + ( {m}_{t}^{( i )} - {\hat{m}}_{t}^{( i )} ) {( {m}_{t}^{( i )} - {\hat{m}}_{t}^{( i )} )}^{T} )$$

$$\{ I \} = \{ I \} - \{ L \}$$

$$end$$

where the merging threshold is U. Finally, a limiting step 53 may be performed, which simply deletes all but the V components with the highest weights, where V is some predetermined number. (In alternative embodiments the merging step 52 and/or limiting step 53 may be omitted, or the steps may be performed in a different order, for example the merging step 52 could be performed before the pruning step 51.)

Following the prune/merge step 10, a set of Gaussian components 11 remains. This is the final set of Gaussian components for time step t. The above process can then be repeated to give the components for time step t+1, and so on.

The process of the GM-PHD implementation described so far shows how the Gaussian components for each time step are obtained. At each stage, the Gaussian components are used to obtain the tracks which are the final output of the implementation, in other words the tracks of the cells.

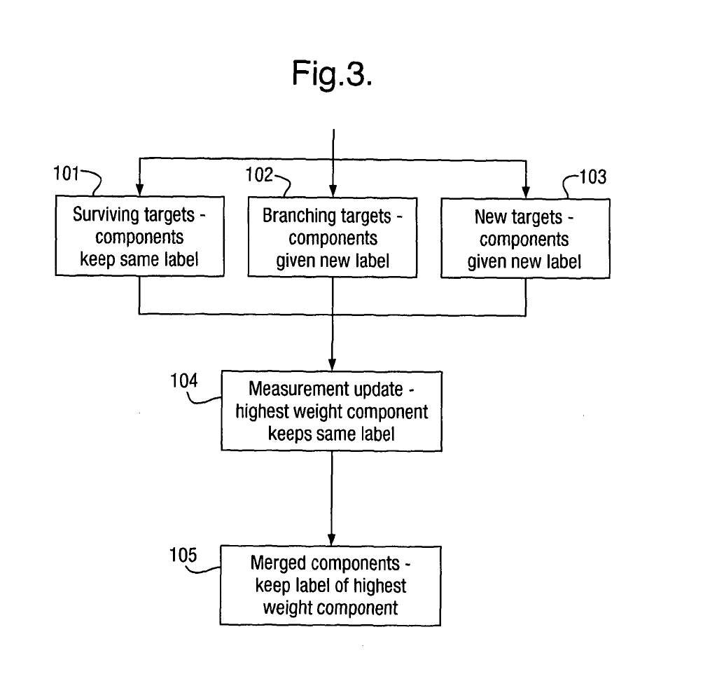

At time t−1, as well as a set of Gaussian components 1, there will also be a set of tracks 12 as previously obtained. The new set of Gaussian components 11 are used, along with the tracks 12, to obtain an updated set of tracks 13. Each Gaussian component is given a unique label, as shown in the flowchart of FIG. 3.

The components 1 are first updated by the motion model. Gaussian components updated by the surviving target model are given the same label as the previously existing component from which they derive (step 101). Components created by the branching target model and new target models are given new unique labels (steps 102 and 103).

The components are then updated by the measurement model. In this case, as discussed above, n measurements will result in n+1 components for each original component. The component with the highest weight is given the same label as the component from which it derives, and the other components are given new unique labels (step 104).

Finally, any merged components are given the label of the highest weighted component of the components from which they are derived (step 105).

The labelled components obtained at each time step are used to obtain the tracks which are the final output of the GM-PHD implementation.

In a first embodiment, the labelled components are analysed to identify any labels that are present for a number of consecutive time steps. As noted above, each Gaussian component can be broadly considered to correspond to a single possible target. As components maintain the same label if they are the result of the surviving target model, a sequence of components with the same label indicates the movement of a single target. A sequence of components with the same label, with a weight above a predetermined threshold, can therefore be declared as a track. (The threshold ensures tracks are only declared based on components for which there is sufficient evidence that they correspond to an actual target.)

An alternative, advantageous embodiment is shown in FIG. 4. First, as in the first embodiment, sequences of components with the same label are identified as possible tracks (step 201). Tracks with weights below a predetermined threshold are then eliminated as being insufficiently likely to be genuine tracks (step 202). (A track may be considered to be below a threshold if the sum of the weights of the components from which the track is derived are below the threshold. Alternatively, a track may be considered to be below a threshold if the maximum component weight of the components from which the track is derived is below the threshold.) The likely tracks then are analysed to identify any tracks which begin soon after another track ended, and where the beginning of the new track is in close proximity to the old track, and if the tracks are in closer than a predetermined threshold (both in terms of distance and time) the tracks are linked to form a single track (step 203). This final set of tracks is the output of the method.

In a further final step, the tracks can be analysed to extract information concerning the motion of the targets. This information can be used to update the motion model of the method.

1. A method of tracking targets in video data, wherein at each of a sequence of time steps a set of weighted probability distribution components is derived, comprising at each time step the steps:
deriving a new set of components from the components of the previous time step in accordance with a predefined motion model for the targets using a processor;
analysing the video at the current time step using the processor to obtain a set of measurements;
updating the new set of components using the measurements in accordance with a predefined measurement model using the processor; and
analysing the set of components derived at each time step using the processor to derive a set of tracks for the targets.

2. A method as claimed in claim 1, wherein the probability distribution components are Gaussian distributions.

3. A method as claimed in claim 1, wherein the predefined motion model comprises:
a survival model that models the expected behaviour of targets that survive from the previous time step; and
an appearance model that models the expected behaviour of targets that were not present in the previous time step.

4. A method as claimed in claim 3, wherein the appearance model indicates that targets are expected to appear on the boundaries of the area captured by the video data.

5. A method as claimed in claim 3, wherein the predefined motion model further comprises a branching model that models the expected behaviour of targets that produce additional targets from the previous time step.

6. A method as claimed in claim 1, further comprising at each time step the step of deleting any components whose weight is below a predetermined amount.

7. A method as claimed in claim 1, further comprising at each time step the step of merging any components that are within a predetermined threshold.

8. A method as claimed in claim 1 further comprising at each time step the step of deleting all but a predetermined number of components consisting of the components with the highest weights.

9. A method as claimed in claim 1, further comprising at each time step the step of labelling the set of components derived at that time step.

10. A method as claimed in claim 9, wherein components obtained from the motion model are given the same label as the component from which they were derived.

11. A method as claimed in claim 10, wherein the motion model comprises a survival model, and wherein a component obtained from the survival model is given the same label as the component from which it derived.

12. A method as claimed in claim 10, wherein the motion model comprises an appearance model, and wherein components obtained from the appearance model are given a new unique label.

13. A method as claimed in claim 10, wherein the motion model comprises a branching model, and wherein the component with the highest weight obtained from the branching model is given the same label as the component from which it derives.

14. A method as claimed in claim 10, wherein aback is derived from a sequence of components from consecutive time steps with the same label.

15. A method as claimed in claim 14, wherein a track is eliminated if the weights of the components from which the track is derived are below a predetermined threshold.

16. A method as claimed in claim 1, wherein if the start of a second track is within a predetermined time and distance of the end of a first track, the first track and second track are linked to form a single track.

17. A method as claimed in claim 1, wherein the motion model is updated based on the tracks of the targets.

18. (canceled)

19. A computer readable media storing instructions that can be executed on a processor on a to track targets in video data, wherein at each of a sequence of time steps a set of weighted probability distribution components is derived, comprising:
instructions for causing the processor to derive a new set of components from the components of the previous time step in accordance with a predefined motion model for the targets;
instructions for causing the processor to analyze the video at the current time step to obtain a set of measurements;
instructions for causing the processor to update the new set of components using the measurements in accordance with a predefined measurement model; and
instructions for causing the processor to analyze the set of components derived at each time step to derive a set of tracks for the targets.
